(19) United States
(12) Patent Application Publication
(10) Pub. No.: US 2025/0381624 A1
(43) Pub. Date: Dec. 18, 2025

(54) COMPUTER-IMPLEMENTED METHOD FOR DETERMINING CUTTING-GAP WIDTHS FOR A LASER-CUTTING METHOD

(71) Applicant: TRUMPF Werkzeugmaschinen SE + Co. KG, Ditzingen (DE)

(72) Inventors: Jonathan Eberle, Nufringen (DE); Marco Kulig, Leinfelden- Echterdingen (DE)

(21) Appl. No.: 19/319,779

(22) Filed: Sep. 5, 2025

Related U.S. Application Data
(63) Continuation of application No. PCT/EP2024/053865, filed on Feb. 15, 2024.

(30) Foreign Application Priority Data
Mar. 7, 2023 (DE) 10 2023 105 580.1

(51) Int. Cl. B23K 26/40; B23K 26/38; B23K 31/00

(52) U.S. Cl. CPC B23K 26/40; B23K 26/38; B23K 31/006

(57) ABSTRACT

A method for determining cutting-gap widths for a laser-cutting method, in which individual workpiece parts are cut out from a workpiece panel. The method includes inputting workpiece part data for the workpiece parts to be cut out. The method further includes establishing individual risk parameters for the workpiece parts to be cut out regarding a risk of workpiece parts interacting at least in part with a residual skeleton remaining from the workpiece panel by becoming wedged, based on the input workpiece part data. The method further includes determining individual cutting-gap widths for the workpiece parts based on the established individual risk parameters.

### CROSS REFERENCE TO RELATED APPLICATIONS

This application is a continuation of International Application No. PCT/EP2024/053865 (WO 2024/184043 A1), filed on Feb. 15, 2024, and claims benefit to German Patent Application No. DE 10 2023 105 580.1, filed on Mar. 7, 2023. The aforementioned applications are hereby incorporated by reference herein.

### FIELD

The invention relates to a computer-implemented method for determining cutting-gap widths for a laser-cutting method, in which individual workpiece parts are cut out from a workpiece panel.

### BACKGROUND

New fully automated laser-cutting machines, such as, for example, the TruLaser Center 7030 manufactured by Trumpf, pose hitherto unknown challenges. One of these challenges is autonomous or automated removal of workpiece parts cut from a workpiece panel, in particular using passive suction cups and pin shuttles. In this case, after successful cutting out from the residual skeleton remaining from the workpiece panel, the workpiece parts are pushed up from the residual skeleton using the pin shuttles, while the passive suction cups lift the workpiece parts out from above. Incorrect removal can lead to the entire machining center coming to a standstill, which is why robustness is essential for the process of workpiece part removal.

However, the automated removal of workpiece parts from laser flatbed machines is currently not as robust as is desirable, since interactions, in particular wedging, of the workpiece parts with the residual skeleton can impair the removal process.

### SUMMARY

In an embodiment, the present disclosure provides a method for determining cutting-gap widths for a laser-cutting method, in which individual workpiece parts are cut out from a workpiece panel. The method comprises inputting workpiece part data for the workpiece parts to be cut out. The method further comprises establishing individual risk parameters for the workpiece parts to be cut out regarding a risk of workpiece parts interacting at least in part with a residual skeleton remaining from the workpiece panel by becoming wedged, based on the input workpiece part data. The method further comprises determining individual cutting-gap widths for the workpiece parts based on the established individual risk parameters.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a perspective view of a system in the form of a machining center according to an embodiment of the present disclosure;

FIG. 2 illustrates a schematic view of a laser-cutting device as part of the machining center of FIG. 1;

FIG. 3 illustrates a schematic view of a cut workpiece panel;

FIG. 4 illustrates a schematic view of a method according to an embodiment of the present disclosure;

FIG. 5 illustrates a schematic view of a portion of a nesting plan generated according to an embodiment of the method of FIG. 4;

FIG. 6 illustrates a schematic view of a portion of a nesting plan generated according to an embodiment of the method of FIG. 4; and

FIG. 7 illustrates a schematic view of a workpiece part for which cutting-gap widths have been determined according to an embodiment of the method of FIG. 4.

### DETAILED DESCRIPTION

In an embodiment, the present disclosure provides for improving the robustness of the above-described removal process after a laser-cutting method performed by corresponding machining centers.

A computer-implemented method is provided for determining cutting-gap widths for a laser-cutting method in which individual workpiece parts are cut out from a workpiece panel, the method including the following method steps:
(a) inputting workpiece part data for the workpiece parts to be cut out,
(b) establishing individual risk parameters for the workpiece parts to be cut out regarding the risk of workpiece parts interacting at least in part, in particular becoming wedged, with a residual skeleton remaining from the workpiece panel, on the basis of the input workpiece part data, and
(c) determining individual cutting-gap widths for the workpiece parts on the basis of the established individual risk parameters.

It was found that the interaction of cut-out workpiece parts with the residual skeleton remaining from the workpiece panel after the laser-cutting method depends on various factors, with cutting gap, especially cutting-gap width, being a particularly important factor. Fundamentally, it was found that the narrower the cutting gap at a workpiece part to be cut out from the workpiece panel, the higher the probability that this workpiece part and the remaining residual skeleton would interact with one another during removal, in particular that they would become wedged into or together with one another. This applies in particular where the workpiece parts have complex edge geometries.

The method according to the present disclosure now makes it possible, in particular, to analyze the workpiece parts based on their workpiece part data to the effect that critical segments of the workpiece part geometry in the workpiece panel are preventively identified for which a wider cutting gap can make the subsequent process of removing workpiece parts significantly more robust. Since the cutting-gap width is determined individually in each case for workpiece parts, in particular individual workpiece parts, groups of workpiece parts or regions of workpiece parts, this can also be described as dynamic variation of the cutting gap, which represents a preventive measure for avoiding critical situations during workpiece part removal. The proposed dynamic modification of the cutting-gap width at the critical points identified on the basis of the workpiece part data can achieve a significant increase in the robustness of the entire, in particular automated, machining center by which the laser-cutting method and removal are carried out. It must be noted that an increase in cutting-gap width is accompanied by a reduction in productivity. The process parameters for machining by the machining center are optimized for productivity, but the consideration of robustness represents a second optimization component that should not be neglected, especially in the case of automated machining centers, in order to avoid downtimes that can have a major impact on productivity. According to the present disclosure, by individually determining cutting-gap widths, non-critical or less critical workpiece part geometries can be provided with a narrow cutting gap in order nevertheless to be able to carry out the laser-cutting method as quickly and accordingly as efficiently as possible, because the generation of a wider cutting gap typically requires a lower laser-cutting speed and thus slows down the laser-cutting method.

In a method according to the present disclosure, the workpiece parts to be cut out are analyzed on the basis of their workpiece part data in such a way as to establish the risk of interaction of the workpiece parts with the residual skeleton and, from this, an individual cutting-gap width is determined which reduces this risk in order to increase the robustness of the removal process, particularly in an automated machining center.

In particular, it can be provided that the workpiece part data include geometry data and/or material data relating to the individual workpiece parts. The material data can specify the material of the workpiece panel or the individual workpiece parts in greater detail, for example the type of material, in particular which metal or alloy is used, and/or weight, hardness, etc.

In particular, it can be provided that the geometry data comprise or describe the outer contour of the workpiece parts, which is analyzed to establish the individual risk parameters in method step (b). In other words, the geometry data can at least be outline data relating to the outer outlines or two-dimensional shape of the workpiece parts. In this respect, the term “workpiece part geometries” can very particularly also be used. For this purpose, the geometry data can be input as CAD data, for example. It has been shown that the outer contour or outer outlines of the workpiece parts can be evaluated in terms of their complexity. Geometric complexity can be decisive in establishing the respective risk parameter. If a workpiece part or a region thereof is geometrically complex, a higher risk parameter can be established than for a geometrically simple outer contour.

In particular, the individual risk parameters can be established as ‘successful removal probabilities’ for automated removal of the workpiece parts. The risk parameter can fundamentally be a value that is established individually for workpiece parts on the workpiece panel, especially individual workpiece parts, groups of workpiece parts and/or regions, in particular cutting edges, of workpiece parts. In other words, an individual risk parameter can be established for different segments on the workpiece panel, wherein these segments can in each case comprise groups of workpiece parts, individual workpiece parts or regions of workpiece parts. Although it is the case that the finer the segmentation, the longer the computer processing time required, the result is that more detailed individual cutting-gap widths can be determined and applied. The risk parameter is therefore used in the method in particular to distinguish what individual relative and/or absolute risk results from a given workpiece part geometry of one or more workpiece parts with regard in particular to the automated removal of workpiece parts. Individual means in particular that for each workpiece part geometry or each segment on the workpiece panel, which as described can comprise individual workpiece parts, groups of workpiece parts and/or regions, in particular cutting edges, of workpiece parts, a risk of interaction with the residual skeleton is established which may lead to difficulty in particular with regard to automated removal from the machining center.

In turn, determining individual cutting-gap widths means in particular that for each workpiece part geometry or each segment on the workpiece panel, which as described can comprise individual workpiece parts, groups of workpiece parts and/or regions, in particular cutting edges, of workpiece parts, a cutting-gap width is selected individually, in particular from a range of values or individual provided values for the cutting-gap width. This does not necessarily mean that the cutting-gap widths for one or more workpiece parts have to be different, but this is typically the consequence when it comes to machining only critical workpiece part geometries with large cutting-gap widths and to increasing robustness in this regard, while non-critical or less critical workpiece part geometries with small cutting-gap widths can be machined more quickly in order to keep the laser-cutting method productive overall.

In addition, it can be provided that the individual risk parameters are established and/or the individual cutting-gap widths are determined using an AI agent. The advantage of using an appropriate AI (artificial intelligence) agent is that the AI agent, after appropriate training, in particular on a virtual or real machining center, can determine optimum values for productivity (small cutting-gap width) and robustness (large cutting-gap width). The associated AI model and/or AI agent can be implemented in a corresponding computer program product, as explained in greater detail below, and used on a computer, for example on the machining center, or remotely, for example in a cloud-based manner.

Furthermore, it can be provided that the individual risk parameters and/or the individual cutting-gap widths are established and/or determined in each case for individual workpiece parts and/or groups of workpiece parts. This allows different cutting-gap widths to be provided for individual workpiece parts or groups of workpiece parts. A group of workpiece parts can be assembled according to predetermined criteria, in particular geometric criteria, for example size, length of cutting edges, geometric complexity of the outer contour, number of cutting edges, number of corners in the contour, etc. In this way, geometrically largely uniform or similar workpiece parts for which the method is carried out can be grouped together, in order to save computing time and provide a quick result regarding individual cutting-gap widths, rather than evaluating each workpiece part individually with regard to risk parameters and then cutting-gap width.

Additionally or alternatively, it can, however, also be provided that the individual risk parameters and/or the individual cutting-gap widths are established and/or determined in each case for individual regions of workpiece parts, in particular individual cutting edges of workpiece parts. Regions of workpiece parts can in particular comprise contour lines, in particular along multiple cutting edges. Robustness and efficiency down to the level of regions or individual cutting edges of the workpiece part can thus be optimized and particularly detailed optimization can be carried out, which can advantageously exploit rapid change-over times with regard to the laser-cutting parameters of laser-cutting devices.

It can be provided that smaller cutting-gap widths are determined for regions of workpiece parts of simple edge geometry (with regard to their cutting edges) than for regions of workpiece parts of complex edge geometry. In this way, simple geometric cutting edges on a workpiece part can be machined with small cutting-gap widths in order to maintain efficiency during the laser-cutting method, and complex geometric cutting edges on the same workpiece part can be machined with larger cutting-gap widths in order in particular to increase automated workpiece part removal robustness.

Furthermore, it can be provided that different cutting-gap widths are determined for individual workpiece parts or regions of workpiece parts, in particular individual cutting edges of workpiece parts. This not only allows for individual determination of the cutting-gap widths, but also allows for different cutting-gap widths to be selected depending on the risk parameters, particularly per workpiece part or at workpiece part level.

Furthermore, it can be provided that the method further comprises the method step of selecting and/or adapting a configuration of the laser-cutting parameters, in particular laser-cutting speed, laser focus position and/or laser power, for the laser-cutting method for each of the individual cutting-gap widths. The aforementioned laser-cutting parameters can be transferred directly to a laser-cutting device in order to execute the laser-cutting method with the desired cutting-gap widths.

It can also be provided that the method further comprises the method step of nesting the workpiece parts with their previously determined individual cutting-gap widths on the workpiece panel, wherein the individual cutting-gap widths are a characteristic quantity taken into account in the nesting method step. The cutting-gap widths can thus be taken into account when nesting the workpiece parts on the workpiece panel, thereby also ensuring efficient nesting with minimal material waste. Nesting methods, for example using exact or heuristic processes, are fundamentally known and various of the known methods can be used. Nesting refers to (virtual) allocation or placement of the workpiece parts to be cut on the workpiece panel for the subsequent laser-cutting method. In other words, the workpiece parts to be cut out with their workpiece part geometry are assigned unique positions on the workpiece panel or the workpiece panel geometry thereof. This assignment or allocation, which is referred to herein as nesting of the workpiece parts on the workpiece panel, is stored in the nesting plan. The nesting plan can be retrieved during the laser-cutting method. By traversing the cutting edges with a laser according to the contours of the workpiece parts on the workpiece panel in accordance with the nesting plan, the workpiece panel can be cut to obtain the individual workpiece parts. The purpose of nesting is to create a nesting plan that allows the workpiece panel to be used as efficiently as possible, such that as little waste as possible is generated.

The above-mentioned advantages are further achieved by a computer program product according to the present disclosure. The computer program product comprises commands which, when the program is executed by a computer, cause the latter to execute the method according to the present disclosure.

The computer program product can, for example, be a computer program code per se or a product that contains the computer program, for example a data carrier or a data storage device.

The above-mentioned advantages are also achieved by a machining method according to the present disclosure. The machining method is designed for machining a workpiece panel, the machining method including:
the method according to the present disclosure for determining cutting-gap widths, and
a laser-cutting method for cutting out the workpiece parts from the workpiece panel using a laser-cutting beam emerging from a cutting head, wherein, in order to cut out the workpiece parts, the laser-cutting beam traverses cutting contours of the workpiece parts with the individual cutting-gap widths determined according to the method and specified for the laser-cutting method.

In this case, it can be provided that the machining method further comprises automated removal of the cut-out workpiece parts from the residual skeleton remaining from the workpiece panel after the laser-cutting method (or from the workpiece support on which the workpiece panel rests).

The above-mentioned advantages are also achieved by a system according to the present disclosure. The system is set up to machine a workpiece panel, and has:
a computer for executing the method according to the present disclosure or the method of the machining method according to the present disclosure, and
a laser-cutting device for executing the laser-cutting method of the machining method.

The computer, which can be embodied in particular as a control unit or as part of a control unit, can also be used to control the laser-cutting device. The computer can include the computer program product according to the present disclosure.

The computer and the laser-cutting device can be located apart from one another or close to one another. For example, they can be connected to one another via wireless communication (also in the form of a cloud solution) or wired communication, or at least be set up for such a communication link. For example, the computer can be on a remote cloud and wirelessly transmit the generated nesting plan to the laser-cutting device, in particular a machining center with the laser-cutting device. Alternatively, the machining center can generate the above-mentioned nesting plan locally using the computer.

The system can in particular include a machining center, wherein the laser-cutting device can be part of the machining center. It goes without saying that such a machining center can also have further components that are necessary or beneficial for the machining method, such as a workpiece support, a workpiece part collecting device, a (linear) robot for moving the cutting head, etc. If the computer is located in the machining center, the system can in particular be formed by the machining center. Furthermore, the machining center can be an at least partially automated or fully automated machining center. Accordingly, machining can be at least partially automated or fully automated. Advantageously, at least removal of the workpiece parts from a corresponding workpiece support and from the residual skeleton remaining from the workpiece panel is carried out in an automated manner. Various removal means, such as passive suction cups and/or pin shuttles, can be used. In such an automated machining center, in particular a fully automated laser-cutting machine, the method according to the present disclosure or the machining method according to the present disclosure is particularly advantageous because downtimes and human intervention due to workpiece parts becoming wedged in the residual skeleton can be effectively prevented or at least very greatly limited.

Features described herein with respect to the method apply equally to the computer program product, the machining method and the system, and vice versa.

Further details and advantageous configurations of the present disclosure can be found in the following description, on the basis of which exemplary embodiments of the present disclosure are described and explained in greater detail.

In the following description and the figures, the same reference signs are used in each case for identical or mutually corresponding features.

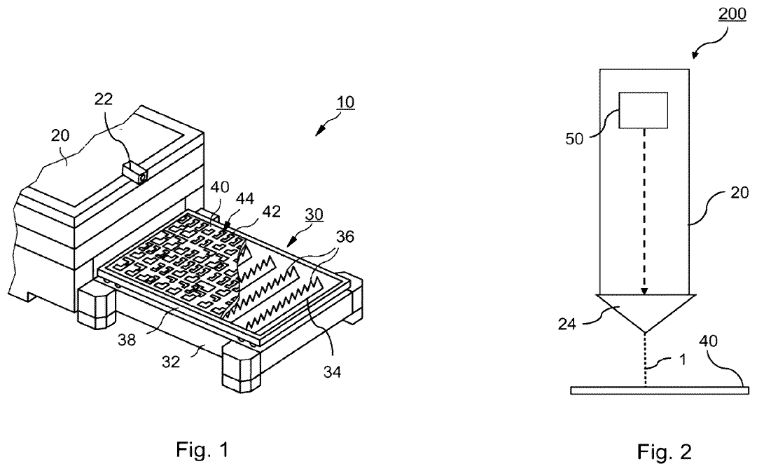

FIG. 1 shows a system 10 in the form of a machining center, more particularly in the form of a laser-cutting machine, more particularly in the form of a laser-cutting flatbed machine tool, with a laser-cutting device 20, in which a laser-cutting method is carried out with a laser-cutting beam 1 (see FIG. 2). In particular, the focus of the laser-cutting beam 1 is guided by a computer 50 (see FIG. 2), in particular in the form of a control device for the machining center, along predetermined cutting contours 42 arranged in a cutting region over a plate-shaped workpiece panel 40, in particular a metal sheet extending substantially two-dimensionally, in order to cut out therefrom workpiece parts 44 with specific shapes or geometries predetermined according to a nesting plan 45 (see FIGS. 4, 5 and 6) (see predetermined shapes of the workpiece parts 44 in the workpiece panel 40 according to the nesting plan 45). The nesting plan 45 can be predetermined by a control plan for the computer 50 and be generated in the context of the method 100 shown schematically in FIG. 4, very particularly in method step 108.

The machining center here further comprises, by way of example, a removal device 30. The removal device 30 is here shown open for the sake of better illustration, but can alternatively also be partially or completely enclosed like the laser-cutting device 20 in FIG. 1. The removal device 30 can advantageously be of automated configuration, in particular with removal means. Advantageously, the entire machining center is fully automated.

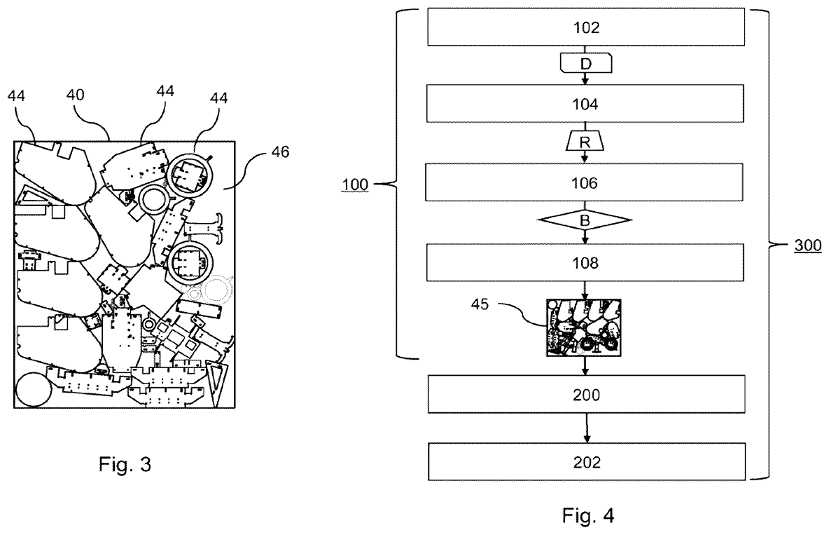

By way of example, the removal device 30 shown comprises a pallet changer 32, as is typically used for manual removal devices 30. The pallet changer 32 is configured to position one or more pallets 38 during manufacture. A workpiece panel 40 to be cut can be placed and stored (as raw or starting material) on a pallet 38 and introduced into the housing of the laser-cutting device 20 for the laser-cutting method. Once the cutting process is complete, the pallet 38 with machined workpiece panel 40 can be moved out of the laser-cutting device 20, as shown in FIG. 1, such that workpiece parts 44 cut according to the nesting plan 45 can be separated manually or in an automated manner from the residual workpiece or residual skeleton 46 remaining from the workpiece panel 40 (see FIG. 3) and removed from the machining center.

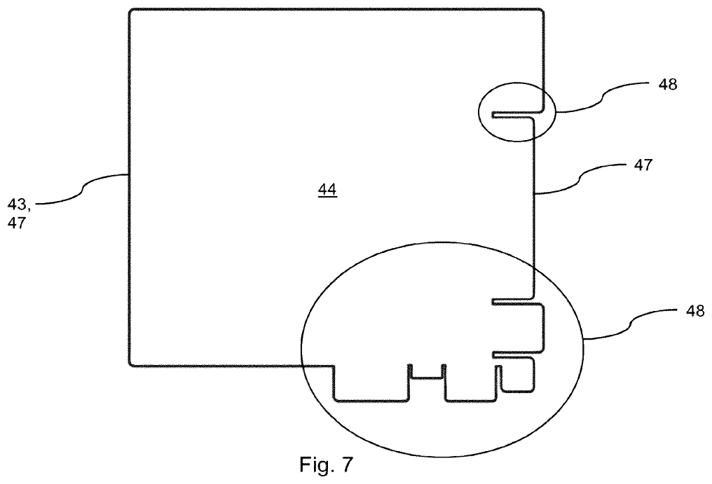

FIG. 2 shows a laser-cutting method 200 in the laser-cutting device 20. A cutting head 24, which is controlled by the computer 50 and emits onto the workpiece panel 40 the laser-cutting beam 1 for cutting out the workpiece parts 44 from the workpiece panel 40, can be freely positioned in the cutting region such that the laser-cutting beam 1 can be guided substantially along any desired two-dimensional cutting contours 42 over the workpiece panel 40 to be cut. In this case, a cutting contour 42 for the laser-cutting beam 1 is predetermined in the computer 50 in each case on the basis of the nesting plan 45 in order to cut out the workpiece parts 44 from the workpiece panel 40. The cutting contour 42 typically comprises cutting edges 43 (see FIG. 7) which are traversed by the laser-cutting beam 1.

The computer 50 is shown here by way of example as a fixed part of the machining center, but can alternatively be wirelessly connected to the machining center and thus form the system 10. A computer 50 extending beyond the computer 50 shown can also be used for the method 100 explained in greater detail below with reference to FIG. 4, wherein the method 100 comprises nesting of the workpiece parts 44 on the workpiece panel 40. The nesting plan 45 generated indicates the arrangement of the individual workpiece parts 44 on the workpiece panel 40, as shown in FIG. 1. In addition, the nesting plan 45 can comprise predetermining piercing points and predetermined first cuts for inserting the laser-cutting beam 1 and guiding said laser-cutting beam 1 along the first cuts to the cutting contour 42.

During laser-cutting, the laser-cutting beam 1 heats the metal of the workpiece panel 40 along the predetermined cutting contours 42 until it melts. A cutting gas jet, in particular of nitrogen or oxygen, can exit the cutting head 24 in the region of the laser-cutting beam 1 and push the molten material of the workpiece panel 40 downwards and out of the gap that is formed. The workpiece panel 40 is thus completely severed by the laser-cutting beam 1 during cutting.

To cut out a workpiece part 44, the laser-cutting beam 1 is moved along the predetermined cutting contours 42 of the respective workpiece panel 40. This begins at one of the previously mentioned piercing points, which lie outside the workpiece parts 44, and then approaches the contour of the respective workpiece part 44, in particular in an arcuate first cut.

In the exemplary embodiment shown, the pallet 38 has a workpiece support 36. The workpiece support 36 has a plurality of support bars 34 which run transversely of, in particular perpendicularly to, the direction of insertion of the workpiece 40 into the laser-cutting device 20 and are aligned parallel to one another. The support bars 34 form supporting regions on which the workpiece panel 40 is laid or placed.

FIG. 1 further shows a camera 22 of the machining center, which is arranged, by way of example, on the laser-cutting device 20 or the housing thereof. The camera 22 can be part of the computer 50 of the machining center or can be connected thereto. The camera 22 is here directed, purely by way of example and for the sake of better illustration, at the removal device 30 and can alternatively or additionally also be directed at the laser-cutting device 20, in particular arranged within the housing of the laser-cutting device 20. In addition, sensors can also be used alternatively or in addition to the camera 22.

FIG. 4 shows a computer-implemented method 100 for generating the nesting plan 45. A corresponding computer system can be partially or completely included in a computer program product. The computer system and the method 100 can be executed, for example, by the computer 50 or another control device or a computer of the machining center.

As shown in FIG. 4, the method 100 has various method steps 102, 104, 106, 108 and comprises a higher-level machining method 300, which also encompasses the laser-cutting method 200 and the removal process 202 in which the cut-out workpiece parts 44 are removed from the workpiece support 36.

In a first method step 102 of the method 100, workpiece part data D of the workpiece parts 44 to be nested on the workpiece panel 40 are input. These workpiece part data D can, for example, take the form of CAD data and include geometry data and/or material data relating to the individual workpiece parts 44. Advantageously, the geometry data comprise the outer contour of the workpiece parts 44, which is traversed by the laser-cutting beam 1 as a cutting contour 42 in the course of the subsequent laser-cutting method 200.

In a second method step 104, individual risk parameters R for the workpiece parts 44 to be cut out, regarding workpiece parts 44 at least partially interacting, in particular becoming wedged, with the residual skeleton 46 remaining from the workpiece panel 40 are established on the basis of the input workpiece part data D.

In a third method step 106, individual cutting-gap widths B for the workpiece parts 44 are determined on the basis of the established individual risk parameters R. These individual cutting-gap widths B are taken into account for nesting of the workpiece parts 44 on the workpiece panel 40 in method step 108. The nesting plan 45 thus generated is used in the laser-cutting method 200 to machine the workpiece panel 40 and then to remove the workpiece parts 44 in method step 202.

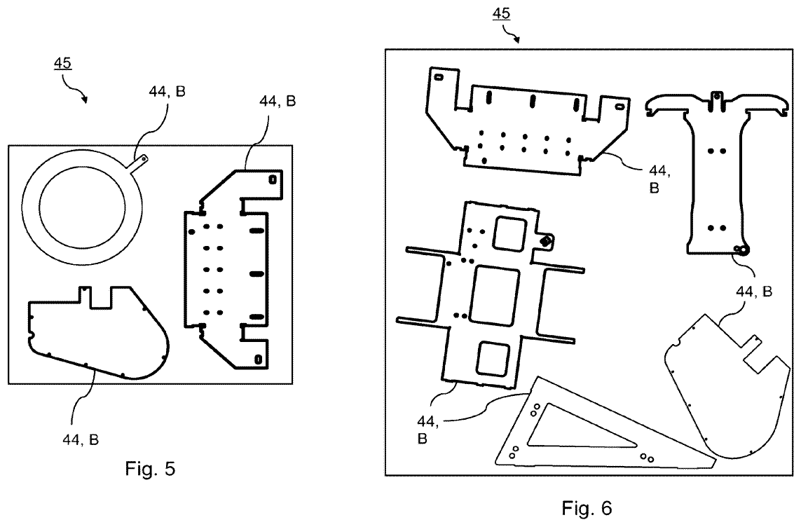

As FIG. 5 shows with reference to a portion of a nesting plan 45 according to a first embodiment of the method 100, the individual risk parameters R and/or the individual cutting-gap widths B can be established and determined for individual workpiece parts 44. In other words, a segment on the workpiece panel 40, relating to individual workpiece parts 44, is here selected for establishing the individual risk parameters R and determining the individual cutting-gap widths B. FIG. 5 thus shows workpiece parts 44 with different geometries, in particular outer contours. These were acquired in method step 102 by inputting the workpiece part data D. In method step 104, individual risk parameters R were then established for the various workpiece parts 44. A different risk parameter R was assigned to each workpiece part 44. The more complex the outer contour of a workpiece part 44, the higher the established risk parameter R (apparent from the cutting-gap widths B, as will now be explained in greater detail). In method step 106, different cutting-gap widths B were thus established individually for each of the workpiece parts 44 based on their different risk parameters R.

In FIGS. 5 and 6, the different cutting-gap widths B are each represented by a different thickness of the contour lines of the workpiece parts 44. Thus, it can be seen in FIG. 5 that the workpiece parts 44 in the illustrated part of workpiece panel 40 or in the nesting plan 45 have a greater cutting-gap width B as the complexity of their outer contour increases. While the workpiece part 44 at top left has a small cutting-gap width B because its outer contour is quite simple, the cutting-gap width B for the workpiece part 44 at bottom right is significantly larger because its outer contour is quite complex. It goes without saying that these examples, as well as other examples in this description of the figures, are merely illustrative and not limiting.

FIG. 6 shows a variant regarding determination of the individual risk parameters R and the individual cutting-gap widths B, wherein different workpiece parts 44 have been grouped based on their workpiece part data D or based on their risk parameters R and the same cutting-gap widths B have in each case been determined for the workpiece parts 44 of the various groups. Thus, the above-mentioned segments are now groups of workpiece parts 44, whereby the computing time required by the computer 50 to execute the method 100 can be reduced.

Finally, FIG. 7 shows a further variant regarding determination of the individual risk parameters R and the individual cutting-gap widths B, this being carried out at workpiece part level, i.e., individual risk parameters R are established and individual cutting-gap widths B determined for different regions, in particular multiple or individual cutting edges 43, of a workpiece part 44. In other words, the above-mentioned segments relate to regions of the workpiece parts 44 themselves.

The workpiece part 44 shown in FIG. 7 in this case has, by way of example, two distinct regions, namely regions with a simple edge geometry 47 and regions with a complex edge geometry 48, wherein it goes without saying that a finer subdivision into more regions is possible based on the complexity of the respective edge geometry, meaning that this example is merely illustrative in nature. A lower risk parameter R is established for the simple edge geometry 47 than for the complex edge geometry 48. Accordingly, for the simple edge geometry 47 of the workpiece part 44, which predominantly has a straight profile and 90° corners of the workpiece part 44, a smaller cutting-gap width B is selected than for the complex edge geometry 48, which is characterized by many small, close-together cutting edges 43 which can result in the complex edge geometry 48 and the residual skeleton 46 becoming wedged. It goes without saying that the individual variants according to FIGS. 5, 6 and 7 can also be used in any desired mutual combination in the method 100.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining cutting-gap widths for a laser-cutting method, in which individual workpiece parts are cut out from a workpiece panel, wherein the method comprises:
(a) inputting workpiece part data for the workpiece parts to be cut out;
(b) establishing individual risk parameters for the workpiece parts to be cut out regarding a risk of workpiece parts interacting at least in part, in particular becoming wedged, with a residual skeleton remaining from the workpiece panel, based on the input workpiece part data; and
(c) determining individual cutting-gap widths for the workpiece parts based on the established individual risk parameters.

2. The method according to claim 1, wherein the workpiece part data includes geometry data and/or material data relating to the individual workpiece parts.

3. The method according to claim 2, wherein the geometry data comprises an outer contour of the workpiece parts, which is analyzed to establish the individual risk parameters in method step (b).

4. The method according to claim 1, wherein the individual risk parameters are established as successful removal probabilities for automated removal of the workpiece parts.

5. The method according to claim 1, wherein the individual risk parameters are established and/or the individual cutting-gap widths are determined using an AI agent.

6. The method according to claim 1, wherein the individual risk parameters and/or the individual cutting-gap widths are established and/or determined in each case for individual workpiece parts and/or groups of workpiece parts.

7. The method according to claim 1, wherein the individual risk parameters and/or the individual cutting-gap widths are established and/or determined in each case for individual regions of the workpiece parts, in particular individual cutting edges of the workpiece parts.

8. The method according to claim 7, wherein smaller cutting-gap widths are determined for the regions of the workpiece parts of simple edge geometry than for the regions of the workpiece parts of complex edge geometry.

9. The method according to claim 1, wherein different cutting-gap widths are determined for individual workpiece parts or regions of the workpiece parts), in particular individual cutting edges of the workpiece parts.

10. The method according to claim 1, further comprising selecting and/or adapting a configuration of laser-cutting parameters, in particular laser-cutting speed, laser focus position and/or laser power, for the laser-cutting method for each of the individual cutting-gap widths.

11. The method according to claim 1, further comprising nesting the workpiece parts with their previously determined individual cutting-gap widths on the workpiece panel, wherein the individual cutting-gap widths are a characteristic quantity taken into account in the nesting step.

12. A computer program product, comprising commands which, when the program is executed by a computer, cause the latter to execute the method according to claim 1.

13. A machining method for machining a workpiece panel, the method comprising:
the method according to claim 1 for determining cutting-gap widths; and
a laser-cutting method for cutting out the workpiece parts from the workpiece panel using a laser-cutting beam emerging from a cutting head, wherein, in order to cut out the workpiece parts, the laser-cutting beam traverses cutting contours of the workpiece parts with the individual cutting-gap widths determined according to the method for determining cutting-gap widths and specified for the laser-cutting method.

14. The machining method according to claim 13, further comprising automated removal of cut-out workpiece parts from the residual skeleton remaining from the workpiece panel after the laser-cutting method.

15. A system for machining a workpiece panel, the systemcomprising:
a computer for executing the method for determining cutting-gap widths of the machining method according to claim 13; and
a laser-cutting device for executing the laser-cutting method of the machining method.
